(19) United States
(12) Patent Application Publication
(10) Pub. No.: US 2003/0123055 A1
(43) Pub. Date: Jul. 3, 2003

(54) Image digitizer having single optical path

(76) Inventor: Stephen Jaeschke, Horsham, PA (US)

Correspondence Address: RATNERPRESTIA, P O BOX 980, VALLEY FORGE, PA, 19482-0980, US

(21) Appl. No.: 10/037,704

(22) Filed: Dec. 31, 2001

(51) Int. Cl. G01N 21/00

(52) U.S. Cl. 356/237.1

(57) ABSTRACT

A method and system for providing different magnified images of an electronic device. The vision system has a single image sensor having a predetermined pixel array, and optics disposed between the sensor and the device and forming a single optical path between the device and the sensor. A first magnification of the device is based upon the projection of at least a first portion of the device via the single optical path onto a predetermined area of the image sensor, and a second magnification of the device is based upon the projection of at least a second portion of the device via the single optical path onto a second predetermined area of the image sensor. The first magnification is based on only the optical magnification of the object while the second magnification is based on the optical magnification and a binning of pixel charge in the image sensor.

### FIELD OF THE INVENTION

This invention relates generally to machine vision systems for semiconductor chip bonding/attaching devices. More specifically, the present invention relates to an apparatus for providing different effective magnifications of an object using an image digitizer and a single optical path.

### BACKGROUND OF THE INVENTION

Semiconductor devices, such as integrated circuit chips, are electrically connected to leads on a lead frame by a process known as wire bonding. The wire bonding operation involves placing and connecting a wire to electrically connect a pad residing on a die (semiconductor chip) to a lead in a lead frame. Once all the pads and leads on the chip and lead frame have been wire bonded, it can be packaged, often in ceramic or plastic, to form an integrated circuit device. In a typical application, a die or chip may have hundreds or thousands of pads and leads that need to be connected.

There are many types of wire bonding equipment. Some use thermal bonding, some use ultra-sonic bonding and some use a combination of both. Prior to bonding, vision systems or image processing systems (systems that capture images, digitize them and use a computer to perform image analysis) are used on wire bonding machines to align devices and guide the machine for correct bonding placement.

Machine vision systems are generally used to inspect the device before, during or after various steps in the fabrication process. During such process steps, it may be necessary to obtain multiple views of the device under different magnification levels to determine whether the device meets predetermined quality standards. One measurement may require a large field of view to include as many fiducals as possible, while a second measurement may require a high resolution to image fine details.

In conventional systems, such multiple magnifications are handled by having a separate camera for each desired magnification level. Such a conventional device is shown in FIG. 1. In FIG. 1, imaging device 100 includes objective lens 104, aperture 106, beam splitter 108, mirror 110, relay lenses 112, 114, and cameras 116, 118. In operation, an image of device 102 is transmitted through object lens 104 as transmitted image 120 and in turn through aperture 106 as image 122. Image 122 is incident on beam splitter 108, which in turn divides the light from image 122 into first divided light rays 124 and second divided light rays 126. Divided light rays 126 are then redirected by mirror 110 as divided light 128.

Relay lenses 112 and 114 are selected so as to provide the desired magnification of divided light 124 and 128, respectively, resulting in magnified images 130 and 132, which are incident on cameras 116 and 118, respectively. This system has a drawback, however, in that it requires a separate camera for each level of magnification desired, thereby increasing size, cost and weight.

A second conventional system 200 is shown in FIGS. 2A and 2B. In FIGS. 2A and 2B, a shutter 218 is used in combination with a second beam splitter 222 to receive two magnifications of device 202 with a single camera 216. As shown in FIG. 2A, first beamsplitter 208 separates light rays 224 into light rays 226, 228, each being of about equal illumination, that is each of light rays 226, 226 is about half the illumination of light rays 224. When shutter 218 is in a first position, light rays 226 are prevented from reaching relay lens 214. On the other hand, light rays 228 are magnified by relay lens 212 to become magnified light rays 230. In turn, magnified light rays 230 are incident on second beamsplitter 222, a portion (about 50%) of which is transmitted to camera 216 as light rays 236. The remaining portion of magnified light rays 230, however, is deflected by second beamsplitter 222 as lost light rays 234. As a result, only about 25% of the light used to illuminate device 202 is actually received at camera 216. In addition, the inclusion of shutter 218 increases the complexity and cost of this system.

Alternatively, when shutter is in a second position, light rays 228 are prevented from reaching relay lens 212, while light rays 226 are directed through relay lens 214 by mirrors 210, 220 as magnified light rays 232. Similar to FIG. 2A, a portion 236 of magnified light rays 232 are received by camera 216 while remaining light rays 234 are lost. As is evident, a large portion of the illumination available for imaging is sacrificed due to the losses associated with first beam splitter 208 and second splitter 222. The light from a single channel hits the second splitter and is split into a reflected portion 234 and transmitted portion 236. Only one of these will be directed to camera 216 while the other is lost. This approach can also have reliability issues with respect to the moving shutter mechanism.

FIGS. 3A and 3B illustrate the details of the imagers used in a conventional dual camera approach. In FIG. 3A, under low optical magnification (2 times in this case) object 302 is received by image sensor 304 as optically magnified image 305, via first optical path 303, and provided to the image processor (not shown). In this example the Field of View (FOV) is about 114 mils×85 mils, and the Depth of Field (DOF) is about 17.75 mils. As shown in FIG. 3B, in order to obtain greater magnification, second imager 306 receives a highly optically magnified image 307 (6 times in this example), via second optical path 309, of a portion 302a of object 302. This highly optically magnified is, in turn, provided to the image processor (not shown). In this example the Field of View (FOV) is about 38 mils×28 mils, and the Depth of Field (DOF) is about 5.92 mils.

As is typical in wire bonding machines, the cameras used in these dual imager conventional image systems are part of the bond head and, as such, add to the mass of the bond head, thereby effecting the speed and accuracy of movement of the bond head. Further, and as discussed above, the use of beam splitters to create multiple optical paths adds loses to the optical image path thereby effecting the quality of the image received by the imager.

### SUMMARY OF THE INVENTION

In view of the shortcomings of the prior art, it is an object of the present invention to provide multiple levels of magnification of a device along a single optical path.

The present invention is a vision system for providing a plurality of images of a device. The system includes a single image sensor having a predetermined pixel array, and optical means disposed between the sensor and the device forming a single optical path between the device and the sensor. A first magnification of the device is based upon a projection of at least a first portion of the device via the single optical path onto a predetermined area of the image sensor, and a second magnification of the device is based upon the projection of at least a second portion of the device via the single optical path onto a second predetermined area of the image sensor.

According to another aspect of the invention, the image sensor aggregates charge from selected pixels of the pixel array into a binned charge.

According to a further aspect of the invention, the first magnification is greater than the second magnification based on the binned charge.

According to yet another aspect of the invention, the first magnification of the device is based on only the optical magnification factor and the second magnification is based on the optical magnification factor and a binning of pixel charge from the pixel array.

According to a further aspect of the invention, an image processor is coupled to the image sensor.

According to still another aspect of the invention, for the second magnification the plurality of pixels are grouped into a plurality of superpixels, each superpixel configured in an M row by N column array of pixels, where at least one of M and N is greater than 1.

According to yet another aspect of the present invention, for the second magnification the image processor scans the superpixels and processes the image based on a sum of the charge of individual ones of pixels within each of the superpixels.

According to a further aspect of the invention, for the first magnification the image processor scans individual ones of a contiguous block of pixels and processes the image based on a respective charge of the individual pixels within the contiguous block.

According to still a further aspect of the invention, the apparatus further comprises illumination means having a wavelength in at least one of i) the visible spectrum, ii) the ultraviolet spectrum, or iii) the infrared spectrum.

According to another aspect of the invention, the illumination is provided via a portion of the single optical path.

According to yet another aspect of the invention, the system is mounted on a semiconductor processing apparatus.

These and other aspects of the invention are set forth below with reference to the drawings and the description of exemplary embodiments of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIG. 1 is schematic representation of a vision system according to the prior art;

FIGS. 2A and 2B are schematic representations of another vision system according to the prior art;

FIGS. 3A and 3B are illustrations of magnifications of an object according to a conventional dual imager system;

FIG. 4 is a perspective view of a semiconductor processing apparatus utilizing a single imager vision system according to an exemplary embodiment of the present invention;

FIG. 5A is an illustration of a pixel array of a single imager according to an exemplary embodiment of the present invention;

FIG. 5B is an illustration of an optical element configuration for the single imager of FIG. 5A according to an exemplary embodiment of the present invention;

FIGS. 5C and 5D are illustrations of providing illumination to a subject device according to exemplary embodiments of the present invention;

FIGS. 6A and 6B are illustrations of pixel binning configurations according to an exemplary embodiment of the present invention; and

FIG. 7 is a block diagram of an exemplary embodiment of the present invention.

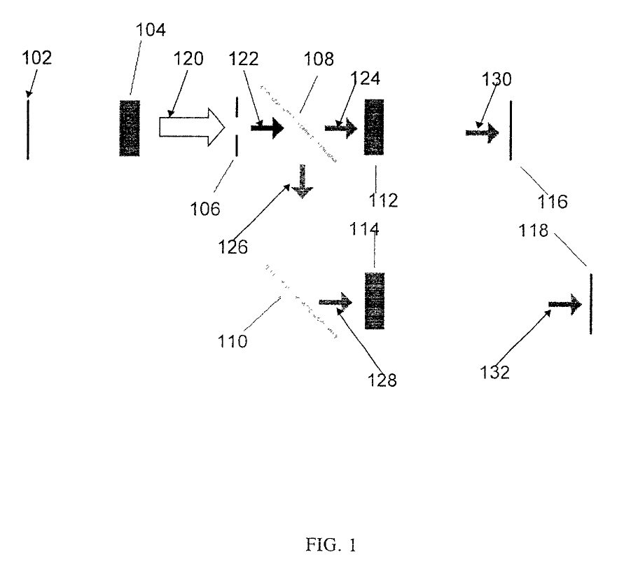

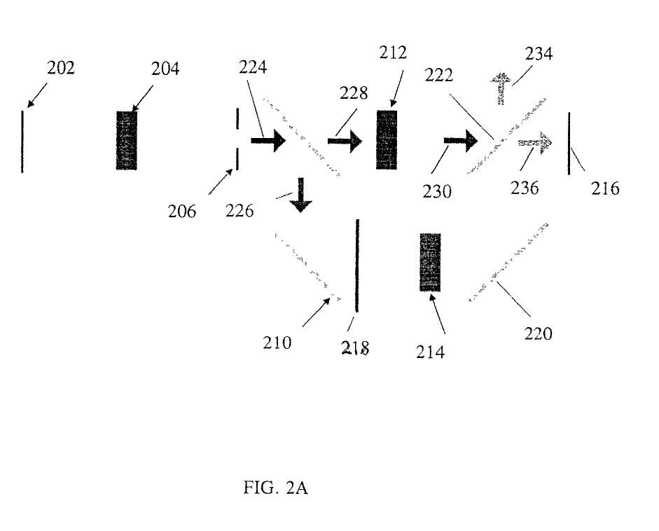

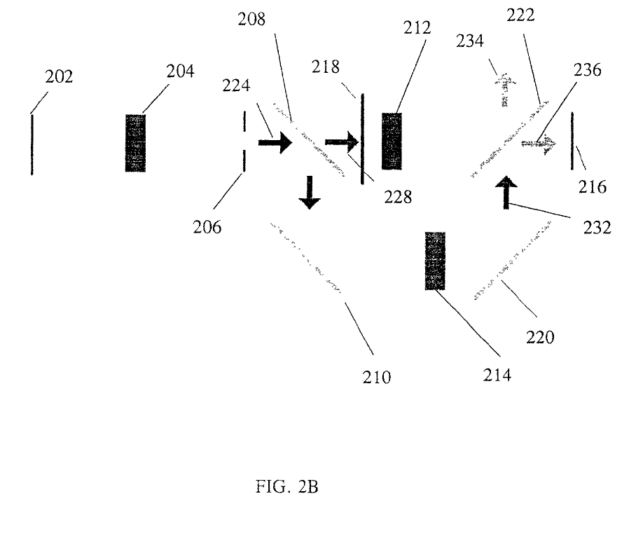

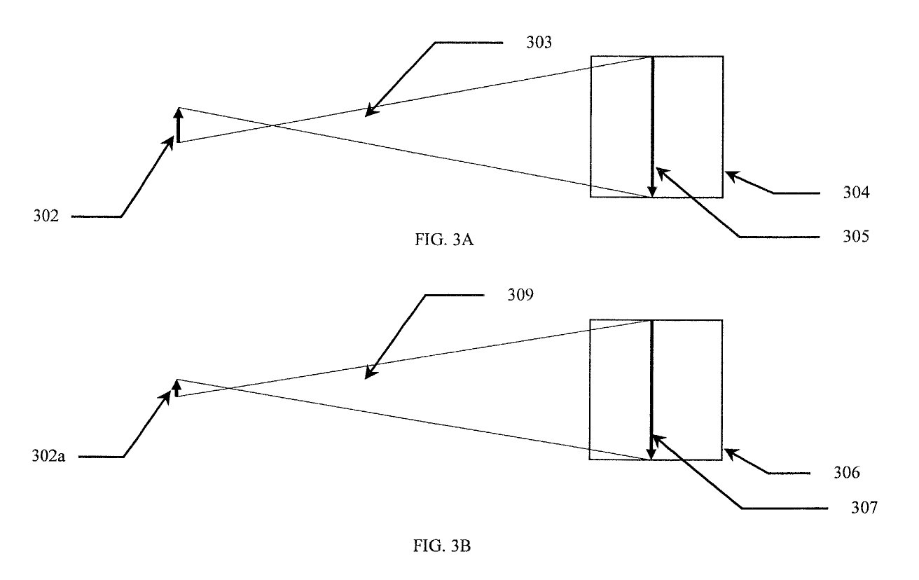

### DETAILED DESCRIPTION

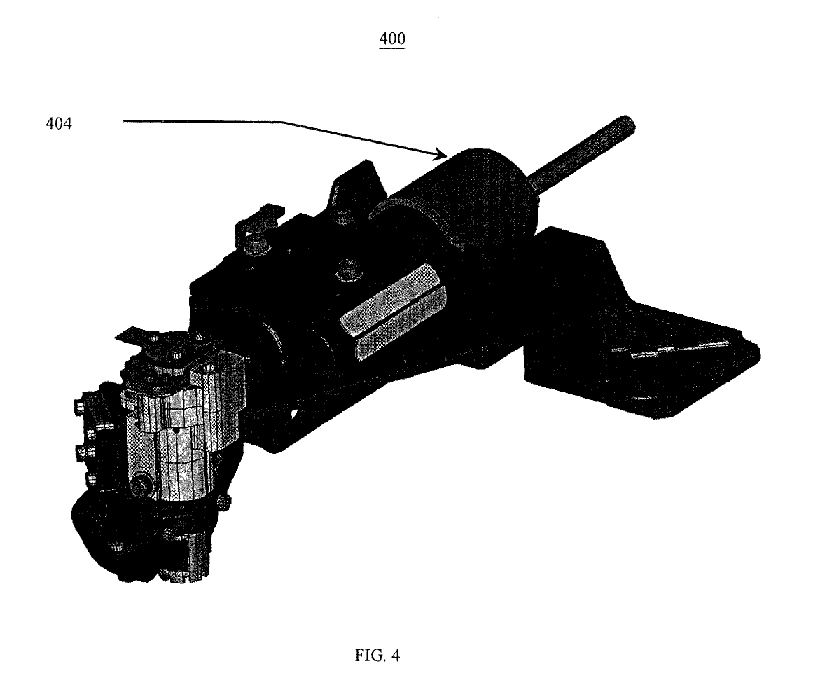

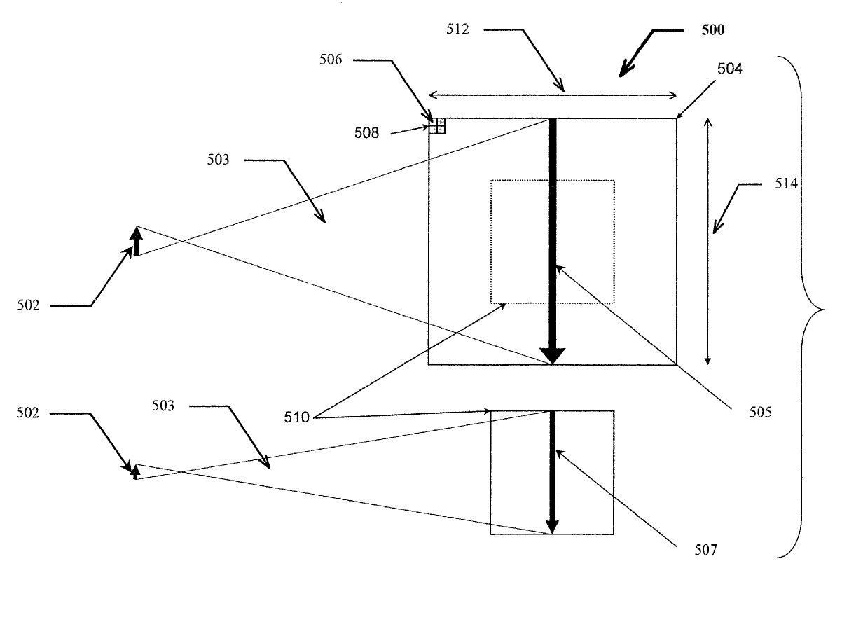

FIG. 4 is a perspective view of a semiconductor processing apparatus 400 according to an exemplary embodiment of the present invention. As shown in FIG. 4, single imaging device 404, is attached thereto to provide multiple views of a workpiece (not shown). Semiconductor processing apparatus 400, may be a bonding machine, an inspection machine, or wafer dicing machine, for example.

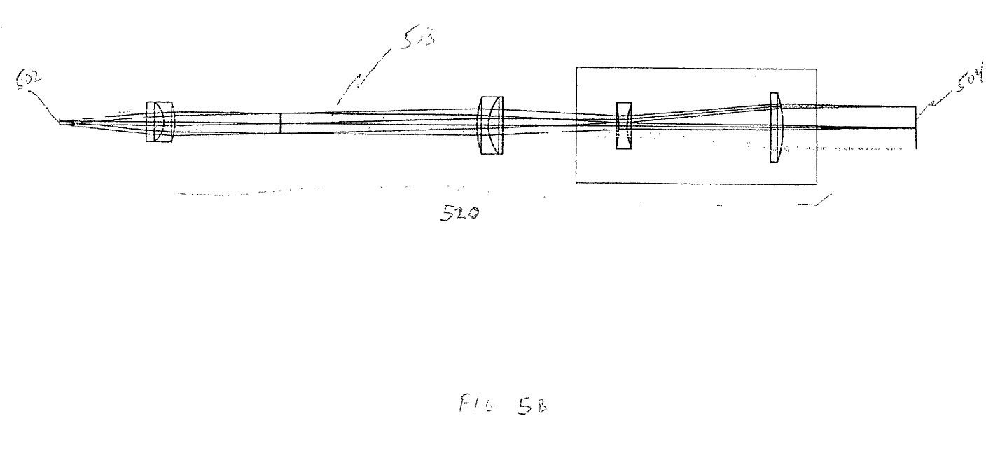

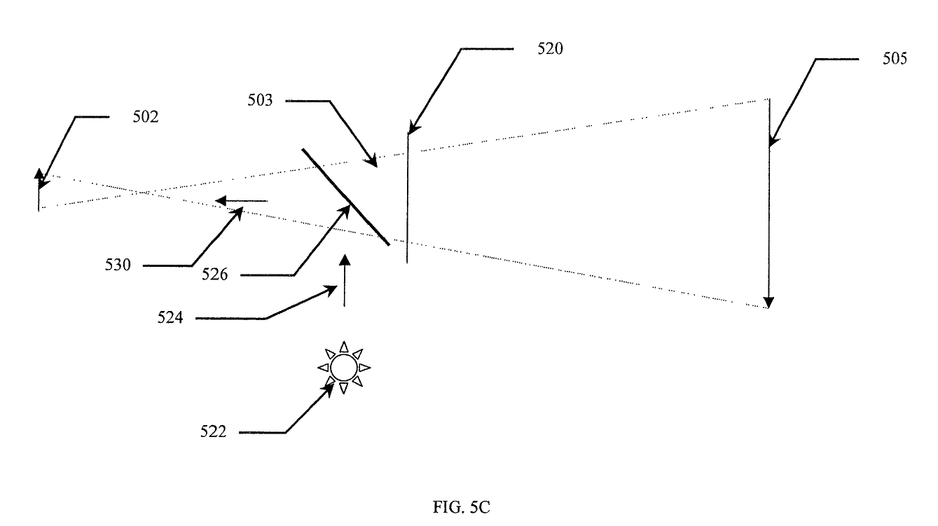

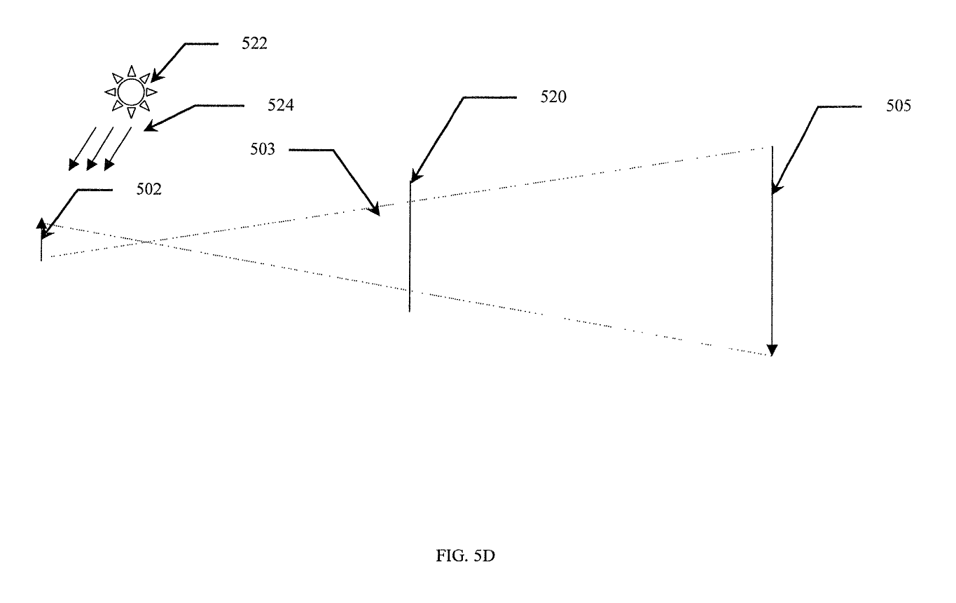

Referring to FIG. 5, an exemplary embodiment of the present invention is shown. In FIG. 5, object 502, such as a portion of a semiconductor device, is magnified by optics (not shown in this figure), having a fixed optical magnification factor, and provided to a single imager 500 via single optical path 503 as magnified image 505. Imager 500, such as a CCD imager or a CMOS device for example, is comprised of an array 504 of pixel elements 506 arranged along columns 512 and rows 514. Magnified image 505 is provided across a portion of the pixel elements 506 and may span the entire height and/or width of pixel array 504.

An example of optics that may be utilized is shown in FIG. 5B. As shown in FIG. 5B, optics 520 is disposed between object 502 and imager 504. It is contemplated that optics 520 may be a combination of any number of a lenses, apertures, mirrors, beam splitters, polarizer, and/or filters.

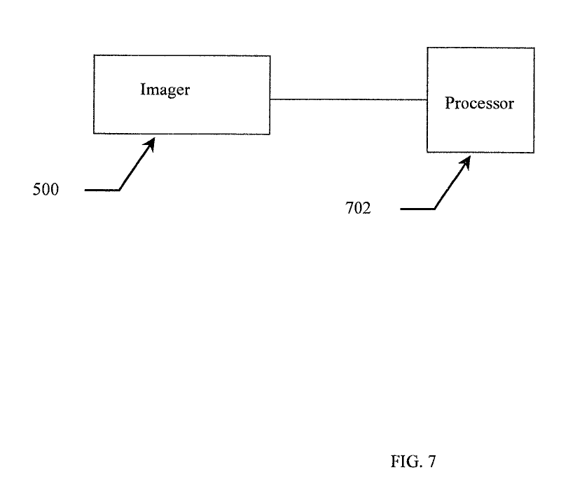

Referring again to FIG. 5A, in order to provide a highly magnified image of object 502 (or a portion thereof), object 502 is magnified by a fixed optical magnification factor via single optical path 503 and onto subblock 510 of pixel array 504. Subblock 510 may be located anywhere within array 504 and have a configuration based on the specific task at hand. Preferably, subblock 510 is located in a central portion of pixel array 504. According to the exemplary embodiment, the effective magnification of object 502, projected onto subblock 510 as image 507, is based solely on the fixed optical magnification factor of optics 520. The charge contained in each individual pixel 506 of subblock 510 is scanned by image processor 702 (shown in FIG. 7) and processed as desired. If desired, subblock 510 may consist of the entirety of pixel array 504.

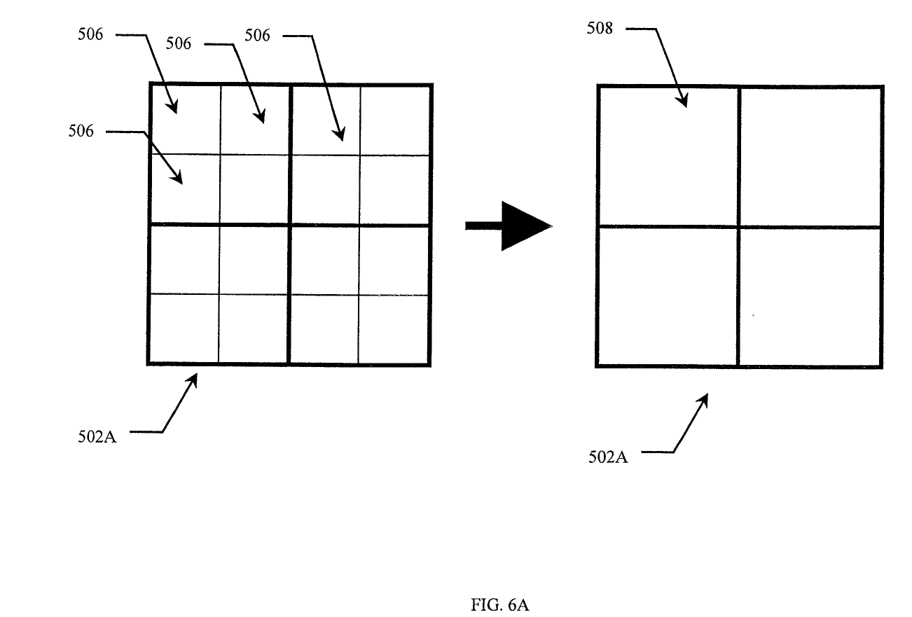

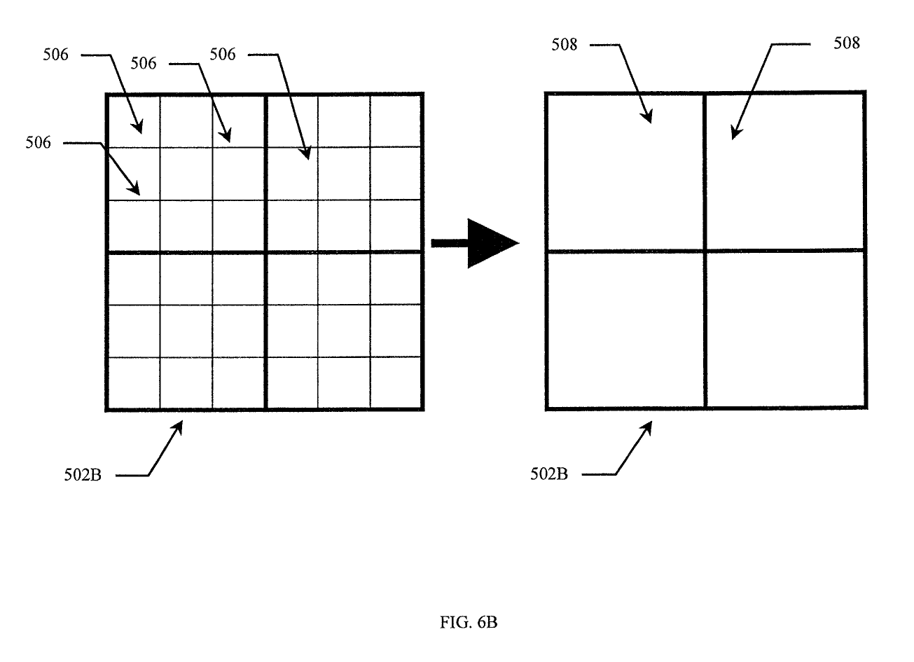

In order to provide additional effective magnifications of object 502, that are less than the fixed optical magnification factor, pixel array 504 is reallocated into super pixels 508. Referring now to FIGS. 6A and 6B, exemplary superpixels 508 are shown. As shown in FIG. 6A, multiple pixels 506 (in this case 4 pixels arranged in a two by two configuration) are aggregated into one superpixel 508. The entirety of pixel array 504 is arranged into super pixels 508 and the charge of individual pixels 506 contained within each respective superpixel are aggregated into a single charge each. These various aggregated charges are scanned by image processor 702 (shown in FIG. 7) and processed based on a sum of the charge of the individual pixels 506 within each of the several superpixels 508. This aggregation of charges is also known as binning. FIG. 6B is an example of a three by three superpixel configuration.

By changing the number and configuration of pixels within the superpixels, the effective magnification of image 502 is reduced. For example, and referring again to FIG. 5A, by binning pixels 506 into two by two superpixels 508, the effective magnification of object 502 is halved. Following this approach, the forming of superpixels from three by three arrays yields an image having an effective magnification of one third the optical magnification factor. Although any pixel array configuration may be used to form superpixels 508 as desired, preferably superpixels 508 are formed in square arrays to avoid distortion across the width versus height of effective image 505. On the other hand, if desired, the aspect ratio of effective image 505 may be adjusted based on other than a square superpixel configuration.

As illustrated, according to the exemplary embodiment of the present invention, lower level magnifications of a device may be achieved via a single optical path and a single set of optics with a single imager by configuring the pixels of the imager into superpixels and binning the charges of the individual pixels contained within each superpixel. A trade off is realized, however, in that the binning of pixel charge has a negative effect on resolution. One the other hand, binning allows for lower light levels than those required where binning is not used.

An exemplary approach to providing illumination is shown in FIG. 5C. As shown in FIG. 5C, illumination to enhance viewing and processing of an image of device 502 may be provided by external source 522. The illumination may be in the visible light spectrum, the ultraviolet spectrum, and/or the infrared spectrum for example. It is contemplated that illumination 524 from source 522 light may be coupled into single optical path 503, or a portion thereof, through beam splitter 526. In this exemplary embodiment, illumination 524 is incident on a surface of beam splitter 526 and reflected toward object 502 as reflected illumination 530 within single optical path 503. Although as illustrated a beam splitter is utilized, other approaches may be used as well. Further, illumination may be introduced before, after, or within optics 520, as desired.

FIG. 5D illustrates another way in which illumination may be provided. As shown in FIG. 5D, illumination 524 from external source 522 (or any other ambient source) is provided directly onto object 502. As above, the illumination may be in the visible light spectrum, the ultraviolet spectrum, and/or the infrared spectrum.

Although the invention has been described with reference to exemplary embodiments, it is not limited thereto. Rather, the appended claims should be construed to include other variants and embodiments of the invention which may be made by those skilled in the art without departing from the true spirit and scope of the present invention.

What is claimed:

1. A vision system for providing a plurality of images of a device, the system comprising:
a single image sensor having a predetermined pixel array; and
optical means disposed between the sensor and the device and forming a single optical path between the device and the sensor,
wherein a first magnification of the device is based upon a projection of at least a first portion of the device via the single optical path onto a predetermined area of the image sensor, and a second magnification of the device is based upon the projection of at least a second portion of the device via the single optical path onto a second predetermined area of the image sensor.

2. The vision system according to claim 1, wherein the image sensor aggregates charge from selected pixels of the pixel array into a binned charge.

3. The vision system according to claim 2, wherein the first magnification is greater that the second magnification based on the binned charge.

4. The vision system according to claim 2, wherein the binned charge is a plurality of binned charges each based on a respective set of selected pixels from the pixel array.

5. The vision system according to claim 4, wherein the second magnification is a plurality of second magnifications each one based on a respective binning configuration.

6. The vision system according to claim 1, wherein the optical means includes at least one of a lens, aperture, mirror, beam splitter, polarizer, and filter.

7. The vision system according to claim 1, wherein the optical means has a predetermined optical magnification factor.

8. The vision system according to claim 7, wherein the first magnification of the device is based on only the optical magnification factor and the second magnification is based on the optical magnification factor and a binning of pixel charge from the pixel array.

9. The vision system according to claim 1, further comprising an image processor coupled to the image sensor.

10. The vision system according to claim 9, wherein the image sensor is comprised of plurality of pixels arranged in a first plurality of pixel columns and a second plurality of pixel rows.

11. The vision system according to claim 10, wherein for the second magnification the plurality of pixels are grouped into a plurality of superpixels, each superpixel configured in an M row by N column array of pixels, where at least one of M and N is greater than 1.

12. The vision system according to claim 11, wherein for the second magnification the image processor scans the plurality of superpixels and processes the image based on a sum of the charge of individual ones of pixels within each of the plurality of superpixels.

13. The vision system according to claim 10, wherein for the first magnification at least a portion of the plurality of row pixels and a portion of the column pixels are used, the respective portions arranged in a contiguous block of pixels.

14. The vision system according to claim 13, wherein for the first magnification the image processor scans individual ones of the contiguous block of pixels and processes the image based on a respective charge of the individual ones of the pixels within the block.

15. The vision system according to claim 14, wherein the block of pixels is an entirety of the pixel array.

16. The vision system according to claim 14, wherein the block of pixels is a subset of the pixel array.

17. The vision system according to claim 1, wherein the system is mounted on a semiconductor processing apparatus.

18. The vision system according to claim 17, wherein the semiconductor processing apparatus is one of a bonding machine, an inspection machine, and a wafer dicing machine.

19. The vision system according to claim 1, further comprising illumination means having a wavelength in at least one of i) a visible spectrum, ii) an ultraviolet spectrum, and iii) an infrared spectrum.

20. The vision system according to claim 19, wherein the illumination means provides illumination to the device via the optical means.

21. The vision system according to claim 20, wherein the illumination is provided via a portion of the single optical path.

22. A vision system for use with a semiconductor fabrication apparatus and providing a plurality of images of a workpiece, the system comprising:
a single image sensor having a predetermined pixel array; and
optical means disposed between the sensor and the workpiece and forming a single optical path between the workpiece and the sensor,
wherein a first magnification of the workpiece is based upon a projection of at least a first portion of the workpiece via the single optical path onto a predetermined area of the image sensor, and a second magnification of the workpiece is based upon the projection of at least a second portion of the workpiece via the single optical path onto a second predetermined area of the image sensor.

23. A method for providing a plurality of images of a workpiece, the system comprising:
providing a single image sensor having a predetermined pixel array; and
disposing optical means having a fixed optical magnification factor between the sensor and the workpiece;
forming a single optical path between the workpiece and the sensor;
providing a first magnification of at least a first portion of the workpiece via the single optical path based on only the fixed magnification factor; and
projecting a second magnification of at least a second portion of the workpiece via the single optical path based on the fixed magnification factor and a configuration of the pixel array.

24. The method according to claim 23, further comprising the step of aggregating charge from selected pixels of the pixel array into a binned charge.

25. The method according to claim 24, further comprising the step of processing the binned charge of the pixel array to form a processed image of the workpiece.

26. The method according to claim 23, further comprising the step of reconfiguring the pixel array into a plurality of superpixels, each superpixel configured in an M row by N column array of pixels, where at least one of M and N is greater than 1.

27. The method according to claim 26, further comprising the step of scanning and processing the plurality of superpixels based on a sum of the charge of individual ones of pixels within each of the plurality of superpixels.
